(19) United States
(12) Patent Application Publication
(10) Pub. No.: US 2014/0127517 A1
(43) Pub. Date: May 8, 2014

(54) COMPOUNDS, METHODS OF MAKING, AND METHODS OF USE

(71) Applicant: Jason J. Locklin, Bogart, GA (US)

(72) Inventor: Jason J. Locklin, Bogart, GA (US)

(21) Appl. No.: 14/124,041

(22) PCT Filed: Jul. 12, 2012
(86) PCT No.: PCT/US12/46405

§ 371 Date: Dec. 5, 2013

Related U.S. Application Data
(60) Provisional application No. 61/508,411, filed on Jul. 15, 2011.

(51) Int. Cl. A01N 25/10

(52) U.S. Cl. CPC A01N 25/10
USPC 428/426; 524/592

(57) ABSTRACT

Embodiments of the present disclosure provide polymer compositions, methods of making polymer compositions, structures having the polymer composition covalently bonded to the surface of the structure, methods of attaching the polymer to the surface of the structure, methods of decreasing the amount of virus on a structure, methods of killing or reducing the amount of virus on a surface, and the like.

### CROSS-REFERENCE TO RELATED APPLICATION

This application claims priority to U.S. provisional application entitled “COMPOUNDS, METHODS OF MAKING, AND METHODS OF USE,” having Ser. No. 61/508,411, filed on Jul. 15, 2011, which is entirely incorporated herein by reference.

### BACKGROUND

Covalent attachment of antiviral compounds to structures such as fabrics and other surfaces can be challenging. Thus, solutions for attaching antiviral compounds to structures are actively being pursued.

### SUMMARY

Embodiments of the present disclosure provide for polymer compositions, methods of making polymer compositions, structures having the polymer composition covalently bonded to the surface of the structure, methods of attaching the polymer to the surface of the structure, methods of decreasing the amount of virus on a structure, methods of killing or reducing the amount of virus on a surface, and the like.

An embodiment of the structure, among others, includes: a polymer covalently attached to a surface of the structure, wherein the structure has an antiviral characteristic, wherein the polymer includes a linear or branched polyethylenimine polymer that has been quaternized with a hydrophobic side chain moiety and a photo cross-linkable moiety.

### BRIEF DESCRIPTION OF THE DRAWINGS

Many aspects of the disclosed devices and methods can be better understood with reference to the following drawings. The components in the drawings are not necessarily to scale, emphasis instead being placed upon clearly illustrating the relevant principles. Moreover, in the drawings, like reference numerals designate corresponding parts throughout the several views

FIG. 1 illustrates a graph showing the virucidal activity of BP-PEI against RSV A2.

FIG. 2 illustrates the virucidal activity of BP-PEI against H1N1(WSN).

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features that may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, polymer chemistry, biology, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in atmospheres. Standard temperature and pressure are defined as 25° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Definitions:

The term “substituted” refers to any one or more hydrogens on the designated atom that can be replaced with a selection from the indicated group, provided that the designated atom's normal valence is not exceeded, and that the substitution results in a stable compound.

The term “aliphatic group” refers to a saturated or unsaturated linear or branched hydrocarbon group and encompasses alkyl, alkenyl, and alkynyl groups, for example.

As used herein, “alkyl” or “alkyl group” refers to a saturated aliphatic hydrocarbon chain and a substituted saturated aliphatic hydrocarbon chain which may be straight, branched, or cyclic, having 1 to 20 carbon atoms, where the stated range of carbon atoms includes each intervening integer individually, as well as sub-ranges. Examples of alkyl groups include, but are not limited to, methyl, ethyl, i-propyl, n-propyl, n-butyl, t-butyl, pentyl, hexyl, septyl, octyl, nonyl, decyl, and the like. The substitution can be with a halogen, for example.

As used herein, “alkenyl” or “alkenyl group” refers to an aliphatic hydrocarbon which can be straight or branched, containing at least one carbon-carbon double bond, having 2 to 20 carbon atoms, wherein the stated range of carbon atoms includes each intervening integer individually, as well as sub-ranges. Examples of alkenyl groups include, but are not limited to, ethenyl, propenyl, n-butenyl, i-butenyl, 3-methylbut-2-enyl, n-pentenyl, heptenyl, octenyl, decenyl, and the like.

The term “arylalkyl” refers to an arylalkyl group wherein the aryl and alkyl are as herein described. Examples of arylalkyl include, but are not limited to, -phenylmethyl, phenylethyl, -phenylpropyl, -phenylbutyl, and -phenylpentyl.

The term “substituted,” as in “substituted alkyl”, “substituted cycloalkyl,” “substituted cycloalkenyl,” substituted aryl,” substituted biaryl,” “substituted fused aryl” and the like, means that the substituted group may contain in place of one or more hydrogens a group such as hydroxy, amino, halo, trifluoromethyl, cyano, —NH(lower alkyl), —N(lower alkyl)₂, lower alkoxy, lower alkylthio, or carboxy, and thus embraces the terms haloalkyl, alkoxy, fluorobenzyl, and the sulfur and phosphorous containing substitutions referred to below.

As used herein, “halo”, “halogen”, or “halogen radical” refers to a fluorine, chlorine, bromine, and iodine, and radicals thereof. Further, when used in compound words, such as “haloalkyl” or “haloalkenyl”, “halo” refers to an alkyl or alkenyl group in which one or more hydrogens are substituted by halogen radicals. Examples of haloalkyl include, but are not limited to, trifluoromethyl, trichloromethyl, pentafluoroethyl, and pentachloroethyl.

The term “antiviral characteristic” refers to the ability to kill and/or inhibit the growth of a virus. A substance having an antiviral characteristic may be harmful to a virus. A substance having an antiviral characteristic can kill the virus and/or prevent or substantially prevent the replication or reproduction of the virus.

Viruses which may be inhibited by compounds of the present disclosure include, but are not limited to: Adenoviruses, Coronaviruses, Cytomegalovirus, Enteroviruses, Epstein-Barr virus, Herpes simplex virus, Hepatitis viruses, Human Immunodeficiency virus, Human Parvoviruses, Influenza viruses, Morbillivirus, Mumps virus, Norwalk viruses, Papillomaviruses, Paromyxovirus, Poxvirus, Rabies virus, Reoviruses, Rotaviruses, Rubella virus, Respiratory Synctial virus, Rhinoviruses, Varicella zoster virus, and the like.

As used herein, the term “fiber” refers to filamentous material that can be used in fabric and yarn as well as textile fabrication. One or more fibers can be used to produce a fabric or yarn. Fibers include, without limitation, materials such as cellulose, fibers of animal origin (e.g., alpaca, angora, wool and vicuna), hemicellulose, lignin, polyesters, polyamides, rayon, modacrylic, aramids, polyacetates, polyxanthates, acrylics and acrylonitriles, polyvinyls and functionalized derivatives, polyvinylidenes, PTFE, latex, polystyrene-butadiene, polyethylene, polyacetylene, polycarbonates, polyethers and derivatives, polyurethane-polyurea copolymers, polybenzimidazoles, silk, lyocell, carbon fibers, polyphenylene sulfides, polypropylene, polylactides, polyglycolids, cellophane, polycaprolactone, “M5” (poly{diimidazo pyridinylene (dihydroxy) phenylene}), melamine-formadehyde, plastarch, PPOs (e.g., Zylon®), polyolefins, and polyurethane.

The term “textile article” can include garments, fabrics, carpets, apparel, furniture coverings, drapes, upholstery, bedding, automotive seat covers, fishing nets, rope, articles including fibers (e.g., natural fibers, synthetic fibers, and combinations thereof), articles including yarn (e.g., natural fibers, synthetic fibers, and combinations thereof), and the like.

### Discussion:

In accordance with the purpose(s) of the present disclosure, as embodied and broadly described herein, embodiments of the present disclosure, in one aspect, relate to polymer compositions, methods of making polymer compositions, structures having the polymer composition covalently bonded to the surface of the structure, methods of attaching the polymer to the surface of the structure, methods of decreasing the amount of virus on a structure, methods of killing or reducing the amount of virus on a surface, and the like.

In an embodiment, the polymer composition (or the polymer disposed on a surface) may have an antiviral characteristic (e.g., kills at least 70%, at least 80%, at least 90%, at least 95%, or at least 99% of the virus on the surface and/or reduces the amount of virus that form or grow on the surface by at least 70%, at least 80%, at least 90%, at least 95%, or at least 99%, as compared to a similar surface without the polymer composition disposed on the surface).

In an embodiment, the structures can include those that may be exposed to virus and/or that virus can grow on such as, without limitation, fabrics, cooking counters, food processing facilities, kitchen utensils, food packaging, swimming pools, metals, drug vials, medical instruments, medical implants, yarns, fibers, gloves, furniture, plastic devices, toys, diapers, leather, tiles, and flooring materials. In an embodiment, the structures may also include live biologic structures (or surfaces of live biologic structures) such as seeds for agricultural uses, tree limbs, and trunk, as well as teeth.

In an embodiment, the structure inherently includes C—H groups on the surface of the structure to interact with the polymer, as described below. In an embodiment, the structure includes a functionalized layer disposed on the structure that includes the C—H groups on the surface to interact with the polymer. In an embodiment, the structure can include surfaces that inherently include C—H groups on the surface of the structure and also can include surfaces that include a functionalized layer disposed on the structure that includes the C—H groups. In an embodiment, the functionalized layer can have a thickness of about 2 nanometers (nm) to 1 micrometer (μm) or about 25 nm to 120 nm.

In an embodiment, the structure can include textile articles, fibers, filters or filtration units (e.g., HEPA for air and water), packaging materials (e.g., food, meat, poultry, and the like food packaging materials), plastic structures (e.g., made of a polymer or a polymer blend), glass or glass like structures having a functionalized layer (e.g., includes a C—H group) on the surface of the structure, metals, metal alloys, or metal oxides structure having a functionalized layer (e.g., includes a C—H group) on the surface of the structure, a structure (e.g., tile, stone, ceramic, marble, granite, or the like) having a functionalized layer (e.g., includes a C—H group) on the surface of the structure, and a combination thereof.

In an embodiment, the polymer is covalently bonded via the interaction of the polymer with a UV light (e.g., about 340 to 370 nm) that causes a C—C bond to form between the polymer and the surface having a C—H group or a layer on the surface having the C—H group. In other words, the polymer can be attached to the surface or the layer on the surface through a photochemical process so the bonding is easy and inexpensive to achieve. Once the covalent bonds are formed, the polymer layer is strongly bound to the surface and can withstand very harsh conditions such as sonication and extended washing steps as well as exposure to harsh environmental conditions (e.g., heat, cold, humidity, lake, river, and ocean conditions (e.g., above and/or under water), and the like).

In an embodiment, the polymer (also referred to as a “polymer composition”) includes a linear or branched polyethyleneimine polymer that has been quaternized with a hydrophobic side chain moiety and a photo cross-linkable moiety. In an embodiment, the molar ratio between hydrophobic side chain moiety and photo cross-linkable moiety can be about 99:1 to 10:90 including about 20:80, about 30:70, about 50:50, about 70:30, about 80:20, ranges between each of these and other ratios in between. In an embodiment, the polyethyleneimine polymer is a linear polyethyleneimine polymer that can include secondary amines. In an embodiment, the polyethyleneimine polymer is a branched polyethyleneimine polymer that can include primary, secondary, and/or tertiary amino groups.

In an embodiment, the polymer can have the following structure

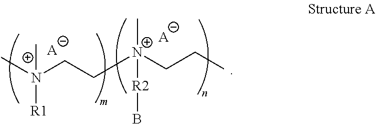

The polyethyleneimine polymer can be linear or branched. R1 is a hydrophobic side chain moiety and is B a photo cross-linkable moiety. A is a counter ion. In an embodiment, R2 can be a linking moiety such a substituted or unsubstituted aliphatic group, a substituted or unsubstituted aryl group, and a substituted or unsubstituted heteroaryl group.

In an embodiment, the polymer can have the following structure (Scheme 1):
example of possible branching structures in branched copolymer

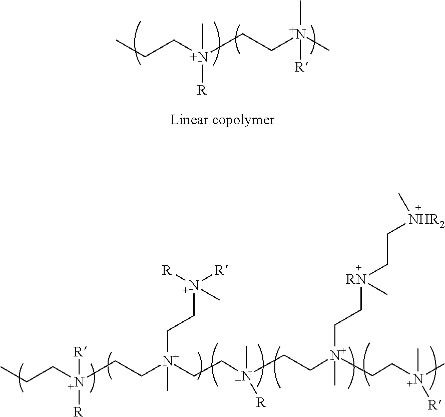

R=alkyl chain such as

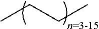

R′=alkyl chain with benzophenone derivative such as

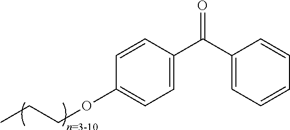

Scheme 1

The above structure is for illustrative, non-limiting purposes. In an embodiment, the structure of the polymer may take on other branching patterns, or comprise single or multiple sites for attachment to surfaces through a photochemical reaction.

In an embodiment, the counter anion (e.g., A) on quaternary amine polymers can include different anions such as chloride, bromide, iodide, alkyl sulfate anions (e.g., methyl sulfate, ethyl sulfate, dodecylsulfate), tetrafluoroborate, and tosylate.

In an embodiment, the polymer composition that includes a linear or branched polyethyleneimine polymer that has been quaternized with a hydrophobic side chain moiety and a photo cross-linkable moiety, is blended with another, secondary polymer to form a polymer blend that can be directly used to manufacture polymers or polymer-based items or as a surface treatment, wherein (i) the secondary polymer can be any thermosetting or thermoplastic polymer, a finish material such as a resin or an adhesive, or other polymer cited herein or (ii) the secondary polymer of (i) may include an optional colored pigment.

In an embodiment, the polymer can have a molecular weight of about 20 kilodaltons to 5000 kilodaltons. In an embodiment, the polymer can have a molecular weight of about 50 kilodaltons to 1000 kilodaltons. In an embodiment, the polymer can have a molecular weight of about 50 kilodaltons to 500 kilodaltons. In an embodiment, the polymer can have a molecular weight of about 50 kilodaltons to 250 kilodaltons. In an embodiment, the polymer can have a molecular weight of about 50 kilodaltons to 150 kilodaltons. In an embodiment, the polymer can have a molecular weight of about 100 kilodaltons to 150 kilodaltons.

In an embodiment, the hydrophobic side chain moiety (e.g., R1) functions to at least provide a hydrophobic characteristic to the polymer. In an embodiment, the hydrophobic side chain can include a hydrocarbon chain such as: octane or its derivatives (e.g., 2-ethylhexane, 3-(methyl)heptane, 6-methylheptane, 2-methylheptane), decane or its derivatives (e.g., 3,7-dimethyl octane, 7- methyl nonane), dodecane or its derivatives (e.g., 4,8-dimethyl decane, 2-methyl undecane, 3-methyl undecane, 9-methyl undecane, 10-methyl undecane), tridecane or its derivatives (e.g., 2-methyl dodecane, 3-methyl dodecane, 6-methyl dodecane, 7-methyl dodecane, 8-methyl dodecane, 9-methyl dodecane, 10-methyl dodecane, 11-methyl dodecane,), pentadecane or its deriatives (e.g., 3,7,11-trimethyl dodecane,13-methyl tetradecane), hexadecane or its derivatives (e.g., 7-(methyl) pentadecane, 7-(3-propyl) tridecane), heptadecane or its derivatives (e.g., 11-methyl hexadecane, 14-methyl hexadecane, 2-methyl hexadecane), octadecane or its derivatives (e.g., 11-methyl heptadecane), nonadecane or its derivatives (e.g. 14-methyl octadecane) eicosane or its derivatives (e.g., 3,7,11,15-tetramethyl hexadecane, 9-(3-propyl) heptadecane), heneicosane or its derivatives (e.g., 20-methylheneicosane), docosane or its derivatives (e.g., 20-methyl heneicosane), tetraconsane (e.g., 11-methyl tricosane), and a combination thereof, where the combination can include a polymer that includes two or more different hydrophobic side changes. In an embodiment, one or more of the hydrocarbon chains can be substituted. In an embodiment, at least one C—H bond in the position alpha to the ammonium group can be replaced by an electronegative group selected from the group consisting of F, Cl, and Br.

In an embodiment, the hydrophobic side chain moiety can include a C═C group in the chain (e.g., at the terminal end). In an embodiment, the hydrophobic side chain moiety can have an alkene group attached to it so that the carbon chain includes one or more C═C bonds.

In an embodiment, the photo cross-linkable moiety (e.g., B) functions to at least undergo a photochemical change to covalently bond with a surface or a layer on the surface of a structure having a C—H group. In an embodiment, the polymer composition is covalently bonded via the interaction of the polymer with a UV light (e.g., about 250 nm to 500 nm or about 340 to 370 nm) that causes a C—C bond to form between the polymer and the surface or a layer on the surface having the C—H group. The UV light can be generated from a UV light source such as those known in the art.

In an embodiment, the photo cross-linkable moiety can include an aryl ketone (about 340 to 400 nm), an aryl azide group (about 250 to 450 nm or about 350 to 375 nm), a diazirine group (about 340 to 375 nm), and the polymer can include a combination of these groups. In an embodiment, the photo cross-linkable moiety can include alkyl-arylketones and diarylketones bearing at least one condensed ring system substituent such as naphtyl and anthracenyl. In an embodiment, the aryl ketone group can include benzophenone (about 340 to 380 nm), acetophenone (about 340 to 400 nm), a naphthylmethylketone (about 320 to 380 nm), a dinaphthylketone (about 310 to 380 nm), a dinaphtylketone derivative (about 320 to 420 nm), or derivatives of each of these. In an embodiment, the photo cross-linkable moiety is a benzophenone group. In an embodiment, the aryl azide group can include phenyl azide, alkyl substituted phenyl azide, halogen substituted phenyl azide, or derivatives of each of these. In an embodiment, the diazirine group can include 3,3 dialkyl diazirine (e.g., 3,3 dimethyl diazirine, 3,3 diethyl diazirine), 3,3 diaryl diazirine (e.g., 3,3 diphenyl diazirine), 3-alkyl 3-aryl diazirine, (e.g., 3-methyl-3-phenyl diazirine), or derivatives of each of these.

In an embodiment, B can be represented by: R3-(C(Struc)OH)—R4-X—. In an embodiment, R3 and R4 can be independently a group such as: a substituted or unsubstituted aliphatic group, a substituted or unsubstituted aryl group, or a substituted or unsubstituted heteroaryl group. In an embodiment, X can be a group such as: O, OR5, N, NR5 (e.g., 1 or more R5s), a substituted or unsubstituted alkyl group, S, SR5 (e.g., 1 or more R5s), a substituted or unsubstituted aryl group, or a substituted or unsubstituted heteroaryl group. In an embodiment, R5 or each R5 can be independently selected from a group such as a substituted or unsubstituted aliphatic group, a substituted or unsubstituted aryl group, or a substituted or unsubstituted heteroaryl group. “Struc” is a structure having C—H functionality.

As mentioned above, the polymer can be disposed on a surface to produce a structure that includes the polymer covalently bonded (via a photochemical process) to the surface of the structure. In an embodiment, the method of disposing the polymer on the surface of the structure includes disposing the polymer on the surface using a method such as spraying, dipping, painting, spin coating, drop casting, and the like. In an embodiment, the surface of the structure has C—H groups that can interact (e.g., form C—C bonds) with the polymer upon exposure to UV light. In an embodiment, the structure has a layer (also referred to as a “functionalized layer”) (e.g., a thin film or self assembling layer) disposed on the surface of the structure. The functionalized layer includes C—H bonds that can interact (form C—C bonds) with the polymer upon exposure to UV light. The structure can be exposed to UV light in many different ways such as direct exposure to a UV light source, exposure to UV light during the spray coating process, exposure to UV light during the dip coating process, exposure to UV light during the spincoating process, exposure to UV light during dip padding, exposure to UV light during nip padding, exposure to UV light during kiss rolling, and exposure to UV light during the drop-casting process.

Either during application of the polymer or once the polymer is disposed on the surface, UV light is directed onto the polymer on the surface. As described above, the UV light causes a photochemical reaction to occur between the polymer and the surface to form one or more covalent bonds (C—C bonds) between the polymer and the surface.

The wavelength of the UV light can be selected based on the photo cross-linkable moiety. In general, the UV light can be active to form the C—C bonds at about 190 to 500 nm, about 190 to 350, about 340 to 400 nm, or about 360 to 370 nm. The specific wavelength(s) that can be used for a particular photo cross-linkable moiety are described herein. In an embodiment, the UV light can be active to form the C—C bonds at a wavelength of about 340 to 370 nm. In an embodiment, the UV light can be active to form the C—C bonds at a wavelength of about 365 nm.

In an embodiment, after the polymer is covalently bonded to the surface, the structure may have an antiviral characteristic that is capable of killing a substantial portion of the virus on the surface of the structure and/or inhibits or substantially inhibits the growth of the virus on the surface of the structure. The phrase “killing a substantial portion” includes killing at least about 70%, at least about 80%, at least about 90%, at least about 95%, or at least about 99% of the virus on the surface that the polymer is covalently bonded, relative to structure that does not have the polymer disposed thereon. The phrase “substantially inhibits the growth” includes reducing the replication of the virus by at least about 70%, at least about 80%, at least about 90%, at least about 95%, or at least about 99% of the virus on the surface that the polymer is covalently bonded, relative to a structure that does not have the polymer disposed thereon.

In an embodiment, once the structure has the polymer layer disposed on the entire surface or select portions of the surface, the structure can be exposed to the environment for which the structure is to be used. Periodically, the structure can be exposed to the polymer material again to ensure that the previous polymer layer was not removed due to normal wear.

### EXAMPLES

### Virucidal Testing Protocol:

BP-PEI Copolymer:

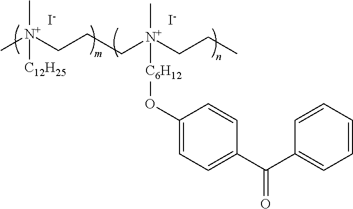

The sterile (autoclaved) round glass coverslips were coated with 100 pL of different molar concentrations of BP-PEI copolymer. Solutions were made using ethanol or other alcoholic solvents. Suspensions were also used with PBS. The coated coverslips and non-coated coverslips (control) were placed in 6 well plates and irradiated with UV light for 5 minutes. A virus solution of 20 μl of ˜10⁶ concentration was added at the center of the coverslip and a second non-coated sterile coverslip was put on top of treated coverslip in a sandwich structure to cover entire surface and ensure no air bubbles. The coverslips were then incubated for 30 minutes at room temperature. The coverslips were dislodged using 500 μl minimum essential medium (MEM, 0.05% BSA). The top coverslip was removed with sterile forceps. The top and bottom coverslips were rinsed with MEM to suspend the viral particles and the obtained 500 μl viral suspension was transferred to Eppendorf tube. The plaque assay was prepared by serial dilution and 100 μl of each dilution was added onto Madin-Darby Canine Kidney (MDCK) epithelial cells monolayer in 12 well plates. The final volume of 300 μl was made by addition of 200 μl (MEM and L-glut) in each well and incubated for 2 hours at 37° C. and 5% CO₂. Plaque medium of 1 ml Avicel/2×overlay+TPCK Trypsin (1:1000 dilution) overlay was used, followed by incubation for 48 hours at 37° C. and 5% CO₂. Finally, the number of plaque forming units (pfu) was counted using fixation and crystal violet staining technique.

TABLE 1
Virucidal activity after 30 minutes exposure
to PEI coated slides against RSA A2

| | | Final titer (pfu/mL) after exposure to slides | | | |
|---|---|---|---|---|---|
| | Initial titer | Control | PEI coated slide | | |
| RSA A2 | (pfu/mL) | slide | 40 μM | 80 μM | 120 μM |
| | 3.30E+06 | 3.30E+06 | 2.13E+06 | 1.53E+06 | 1.83E+06 |
| Virus titer | — | — | 0 | 0 | 0 |
| log reduction | | | | | |

TABLE 2
Virucidal activity after 30 minutes exposure
to PEI coated slides against H1N1 (WSN)

| | | Final titer (pfu/mL) after exposure to slides | | | |
|---|---|---|---|---|---|
| H1N1 | Initial titer | Control | PEI coated slide | | |
| (WSN) | (pfu/mL) | slide | 40 μM | 80 μM | 120 μM |
| | 7.00E+06 | 5.52E+06 | 3.77E+05 | 1.10E+05 | 1.75E+05 |
| Virus titer | — | — | ~1.0 | ~1.0 | ~1.0 |
| log reduction | | | | | |

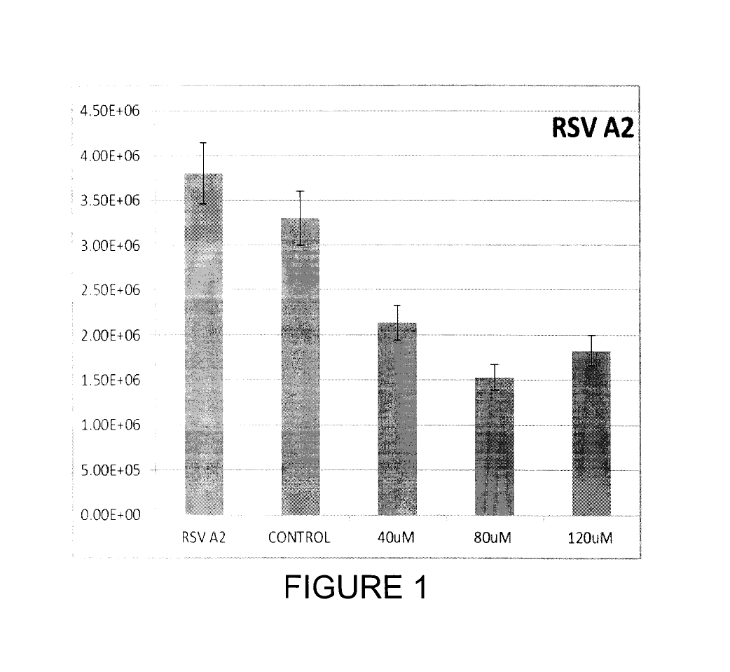

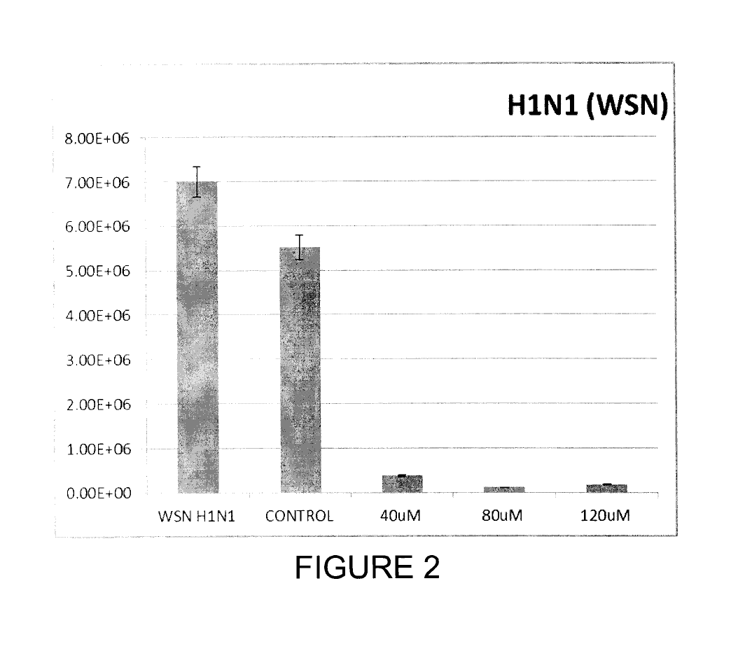

The BP-PEI coated substrates were tested against respiratory syncytial virus (RSA, strain A2) and influenza virus (strain WSN/H1N1) using plaque assay study. Three different coating concentrations, namely, 40, 80 and 120 μM of copolymer were used for the study. Best results were observed at 80 μM against both viruses (Table 1 and 2) (FIGS. 1 and 2) for 30 minute incubation period. A one log reduction of influenza virus was seen in the case of H1N1 against all three different concentrations used in the study (FIG. 2). At 80 μM, reduction of H1N1 titer was greater than 85%.

It should be noted that RSV is a RNA, enveloped virus of the Paramyxoviridae family. H1N1 is a RNA, enveloped virus of the Orthomyxoviridae family. It is the causative agent of influenza.

Embodiments of the present disclosure have shown, yet unoptimized, activity against these airborne viruses, with reduction of about 55% to 85% of viral titer.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

Many variations and modifications may be made to the above-described embodiments. All such modifications and variations are intended to be included herein within the scope of this disclosure and protected by the following claims.

Therefore, at least the following is claimed:

1. A structure, comprising:
a polymer covalently attached to a surface of the structure, wherein the structure has an antiviral characteristic, wherein the polymer includes a linear or branched polyethylenimine polymer that has been quaternized with a hydrophobic side chain moiety and a photo cross-linkable moiety.

2. The structure of claim 1, wherein the antiviral characteristic causes a substantial amount of virus to be killed.

3. The structure of claim 1, wherein the antiviral characteristic causes a viral growth to be inhibited or substantially inhibited.

4. The structure of claim 1, wherein the antiviral characteristic of the surface is characterized in that it kills greater than about 90% of the virus on the surface.

5. The structure of claim 1, wherein the antiviral characteristic of the surface is characterized in that it kills greater than about 99% of the virus on the surface.

6. The structure of claim 1, wherein the polymer can have the following structure 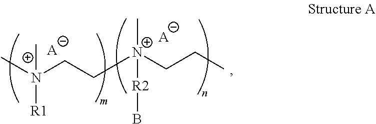
wherein R1 is a hydrophobic side chain moiety, B is a photo cross-linkable moiety, A is a counter ion, and R2 is a linking moiety.

7. The structure of claim 6, wherein B is R3-(C(Struc)OH)—R4-X—, where R3 and R4 are independently selected from the group consisting of: a substituted or unsubstituted aliphatic group, a substituted or unsubstituted aryl group, and a substituted or unsubstituted heteroaryl group; X is selected from the group consisting of: O, OR5, N, NRS, a substituted or unsubstituted alkyl group, S, SR5, a substituted or unsubstituted aryl group, and a substituted or unsubstituted heteroaryl group; wherein R5 is selected from the group consisting of: a substituted or unsubstituted aliphatic group, a substituted or unsubstituted aryl group, and a substituted or unsubstituted heteroaryl group, wherein Struc is a structure having C—H functionality.

8. The structure of claim 6, wherein R1 is selected from the group consisting of: hexane; heptane; octane; nonane; decane; undecane; dodecane; tridecane; tetradecane; pentadecane; hexadecane; heptadecane; heptadecane; octadecane; eicosane; heneicosane; docosane; tricosane; and a combination thereof, wherein at least one C—H bond in the position alpha to the ammonium group has been replaced by an electronegative group selected from the group consisting of F, Cl, and Br

9. The structure of claim 6, wherein the structure is selected from the group consisting of: a fabric, a textile article, a natural fiber, a synthetic fiber, a porous membrane, a plastic structure, a oxide structure having a functionalized layer on the surface of the structure, a metal structure having a functionalized layer on the surface of the structure, a glass structure having a functionalized layer on the surface of the structure, and a combination thereof.

10. The structure of claim 9, wherein the functionalized layer has a thickness of about 2 nanometers (nm) to 1 micrometer (μm).

11. The structure of claim 6, wherein the structure is selected from fabrics, cooking counters, food processing facilities, kitchen utensils, food packaging, swimming pools, metals, drug vials, medical instruments, medical implants, yarns, fibers, gloves, furniture, plastic devices, toys, diapers, leather, tiles, and flooring materials.

12. The structure of claim 6, wherein the structure is selected from textile articles, fibers, filters or filtration units, packaging materials, plastic structures, glass or glass like structures having a functionalized layer that includes a C—H group on the surface of the structure, metals, metal alloys, or metal oxides structure having a functionalized layer that have a C—H group on the surface of the structure, a tile, stone, ceramic, marble, or granite, structure having a functionalized layer that includes a C—H group on the surface of the structure, and a combination thereof.

13. The structure of claim 1, wherein the photo cross-linkable moiety is selected from the group consisting of: an aryl ketone, an aryl azide group, a diazirine group, and a combination thereof.

14. The structure of claim 13, wherein the aryl ketone is selected from the group consisting of: an acetophenone, an acetophenone derivative, a benzophenone, a benzophenone derivative, a naphtylmethylketone, a dinaphtylketone, a dinaphtylketone derivative, and a combination thereof.

15. The structure of claim 1, wherein the linear or branched polyethylenimine polymer that has been quaternized with a hydrophobic side chain moiety and a photo cross-linkable moiety and is represented by: 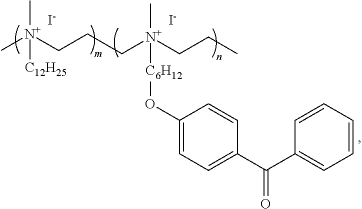
wherein attachment occurs via the ═O to form a covalent bond and an OH group.

16. The structure of claim 1, wherein the polymer can have the following structure 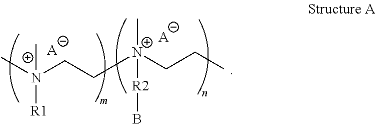
wherein R1 is a hydrophobic side chain moiety and is selected from the group consisting of: hexane; heptane; octane; nonane; decane; undecane; dodecane; tridecane; tetradecane; pentadecane; hexadecane; heptadecane; heptadecane; octadecane; eicosane; heneicosane; docosane; tricosane; and a combination thereof, wherein at least one C—H bond in the position alpha to the ammonium group has been replaced by an electronegative group selected from the group consisting of F, Cl, and Br, B a photo cross-linkable moiety, A is a counter ion, and R2 is a linking moiety that is selected from the group consisting of: a substituted or unsubstituted aliphatic group, a substituted or unsubstituted aryl group, and a substituted or unsubstituted heteroaryl group, B a photo cross-linkable moiety wherein B is R3-(C(Struc)OH)—R4-X—, where R3 and R4 are independently selected from the group consisting of: a substituted or unsubstituted aliphatic group, a substituted or unsubstituted aryl group, and a substituted or unsubstituted heteroaryl group; X is selected from the group consisting of: O, OR5, N, NR5, a substituted or unsubstituted alkyl group, an S group, a substituted or unsubstituted aryl group, and a substituted or unsubstituted heteroaryl group; wherein R5 is selected from the group consisting of: a substituted or unsubstituted aliphatic group, a substituted or unsubstituted aryl group, and a substituted or unsubstituted heteroaryl group, wherein Struc is a structure having C—H functionality and is selected from the group consisting of: a fabric, a textile article, a natural fiber, a synthetic fiber, a porous membrane, a plastic structure, a oxide structure having a functionalized layer on the surface of the structure, a metal structure having a functionalized layer on the surface of the structure, a glass structure having a functionalized layer on the surface of the structure, and a combination thereof.
